(19) United States
(12) Patent Application Publication
(10) Pub. No.: US 2006/0082539 A1
(43) Pub. Date: Apr. 20, 2006

(54) Display device and method

(76) Inventors: Jeung-Soo Kim, Seou (KR); Kyoung-Don Lee, Suwon-si (KR)

Correspondence Address: CANTOR COLBURN, LLP, 55 GRIFFIN ROAD SOUTH, BLOOMFIELD, CT, 06002, US

(21) Appl. No.: 11/247,819

(22) Filed: Oct. 11, 2005

(30) Foreign Application Priority Data
Oct. 19, 2004 (KR) 2004-83682

(51) Int. Cl. G09G 3/36

(52) U.S. Cl. 345/102

(57) ABSTRACT

A display device includes a backlight assembly, a display panel unit, and a control member. The backlight assembly emits a first light and a second light. The display panel unit includes a first display panel and a second display panel, and receives the first light and the second light to display a first image and a second image, respectively. The control member controls an interval between the backlight assembly and the display panel unit. The interval is controlled in a method of positioning the first display panel, thereby emphasizing the display panel unit and diversifying a design of the display device.

This application claims priority to Korean Patent Application No. 2004-83682, filed on Oct. 19, 2004 and all the benefits accruing therefrom under 35 U.S.C. §119, and the contents of which in its entirety are herein incorporated by reference.

### BACKGROUND OF THE INVENTION

1. Field of the Invention

The present invention relates to a display device, a liquid crystal display (“LCD”) device, and a method. More particularly, the present invention relates to a display device capable of controlling a height of a display panel installed therein, an LCD device capable of controlling a height of an LCD panel installed therein, and a method of controlling a height of a display panel installed in a display device.

2. Description of the Related Art

Generally, a liquid crystal display (“LCD”) device displays an image using electrical and optical characteristics of liquid crystal installed therein. The LCD device has various advantages, such as, for example, thin thickness, small volume, and lightweight structure in comparison with a cathode ray tube (“CRT”). Thus, the LCD device has been widely used in applications such as a portable computer, a communication device, a television set, etc.

The LCD device includes a liquid crystal controlling unit that controls liquid crystal, and a light providing unit that provides the liquid crystal with light. For example, the LCD device includes an LCD panel serving as the liquid crystal controlling unit and a backlight assembly serving as the light providing unit.

Recently, an LCD device displaying a same image or a different image in two directions has been widely used for a relatively small-sized LCD device. Such an LCD device includes two LCD panels, including a main LCD panel and a sub LCD panel. In general, the sub LCD panel has a smaller size than the main LCD panel.

Also recently, a design of the LCD device has been considered very important. For example, there have been attempts to emphasize the sub LCD panel. In order to emphasize the sub LCD panel, the sub LCD panel requires an increased height with respect to a thickness direction of the LCD device. However, when the sub LCD panel is disposed in a receiving container, the sub LCD panel is designed to have a relatively low height in order to have a small size, a lightweight structure, etc.

Accordingly, it is impossible for the sub LCD panel to have a relatively high height in the thickness direction of the LCD device, and therefore the sub LCD panel cannot be emphasized and a design of the LCD device cannot be diversified.

### BRIEF SUMMARY OF THE INVENTION

The present invention obviates the above problems and thus the present invention provides a display device capable of controlling a height of a display panel installed therein.

The present invention also provides an LCD device capable of controlling a height of an LCD panel installed therein.

The present invention also provides an LCD device having a sub LCD panel stably installed therein.

In one exemplary embodiment of the present invention, a display device includes a backlight assembly, a display panel unit, and a control member. The backlight assembly emits a first light and a second light. The display panel unit receives the first light and the second light to display a first image and a second image, respectively. The display panel unit, for example, includes a first display panel and a second display panel. The first display panel is disposed on a first side of the backlight assembly to display the first image using the first light emitted from the backlight assembly. The second display panel is disposed on a second side of the backlight assembly to display the second image using the second light emitted from the backlight assembly. The control member controls a first interval between the backlight assembly and the display panel unit. The control member, for example, controls an interval between the backlight assembly and the first display panel unit. The control member may include a mold frame to support the first display panel. The first interval may be varied by controlling the first thickness of a support in the mold frame.

The display device may further include a receiving container. Here, the control member, for example, may include a tape panel disposed between the receiving container and the first display panel. The first interval may be varied by controlling a thickness of the tape panel. The control member, for example, may instead include a protruded portion formed on the bottom plate of the receiving container to support the first display panel. The first interval may be varied by controlling a height of the protruded portion.

In another exemplary embodiment of the present invention, an LCD device includes a backlight assembly, a first LCD panel, a second LCD panel, a receiving container, and a mold frame. The backlight assembly emits a first light and a second light. The first LCD panel is disposed on a first side of the backlight assembly to display a first image using the first light emitted from the backlight assembly. The second LCD panel is disposed on a second side of the backlight assembly to display a second image using the second light emitted from the backlight assembly. The receiving container receives the first and second LCD panels and has a bottom plate. The mold frame is disposed on a side of the receiving container to support the first display panel. The mold frame controls an interval between the backlight assembly and the first LCD panel.

In still another exemplary embodiment of the present invention, an LCD device includes a backlight assembly, a first LCD panel, a second LCD panel, and a receiving container. The backlight assembly emits a first light and a second light. The first LCD panel is disposed on a first side of the backlight assembly to display a first image using the first light emitted from the backlight assembly. The second LCD panel is disposed on a second side of the backlight assembly to display a second image using the second light emitted from the backlight assembly. The receiving container receives the first and second LCD panels and has a bottom plate. The receiving container controls an interval between the backlight assembly and the first LCD panel.

In still another exemplary embodiment of the present invention, an LCD device includes a backlight assembly, a first LCD panel, a second LCD panel, and a receiving container. The backlight assembly has a light source that emits a first light and a second light. The first LCD panel is disposed on a first side of the backlight assembly to display a first image using the first light emitted from the backlight assembly. The second LCD panel is disposed on a second side of the backlight assembly to display a second image using the second light emitted from the backlight assembly. The receiving container receives the first and second LCD panels and includes a bottom plate and a guide that is extended from the bottom plate to define a receiving space where the first LCD panel is disposed. The LCD device may further include a mold frame disposed on a first side of the receiving container to support the first LCD panel. Here, the mold frame is combined with the guide using a hook. When the guide supports the first LCD panel, the receiving container may further include a combination member combining the first LCD panel and the receiving container with each other.

In another exemplary embodiment, a method of positioning a first display panel in a display device according to the above described embodiments may include determining a first spacing between the backlight assembly and the first display panel desired for emphasizing the first display panel, determining a second spacing between the bottom plate and the first display panel for acquiring the first spacing, and providing a control member between the bottom plate and the first display panel to achieve the second spacing. The method further includes placing the control member adjacent at least one side of the opening in the bottom plate of the receiving container. The method may include selecting a mold frame as the control member, providing the mold frame with a support supporting the first display panel, and selecting a thickness of the support required for forming at least part of the second spacing. The method may alternatively include selecting a tape panel as the control member, providing the tape panel with a thickness controlling layer, selecting a thickness of the thickness controlling layer required for forming at least part of the second spacing, and adhering the thickness controlling layer between the bottom plate and the first display panel, wherein selecting a thickness of the thickness controlling layer includes selecting layers from a set of layers, layering the selected layers, and forming the thickness controlling layer from the selected layers. The method may alternatively include selecting a protruding member as the control member, selecting a height of the protruding member required for forming at least part of the second spacing, and integrally forming the protruding member with the bottom plate.

According to the above, the control member is placed between a backlight assembly and a display panel, so that an interval therebetween may be controlled. Thus, the interval is controllable with respect to a thickness direction of a display device, thereby emphasizing the display panel and diversifying a design of the display device.

### BRIEF DESCRIPTION OF THE DRAWINGS

The above and other features and advantage points of the present invention will become more apparent by describing in detailed exemplary embodiments thereof with reference to the accompanying drawings, in which:

FIG. 1 is a schematic view illustrating an exemplary embodiment of a display device according to the present invention;

FIG. 2 is an exploded perspective view illustrating a first exemplary embodiment of an LCD device according to the present invention;

FIG. 3 is a cross-sectional view of an exemplary first LCD panel and an exemplary receiving container taken along line I-I′ in FIG. 2;

FIG. 4 is an exploded perspective view illustrating a second exemplary embodiment of an LCD device according to the present invention;

FIG. 5 is a cross-sectional view of an exemplary first LCD panel and an exemplary receiving container taken along line II-II′ in FIG. 4;

FIG. 6 is an exploded perspective view illustrating a third exemplary embodiment of an LCD device according to the present invention;

FIG. 7 is a cross-sectional view of an exemplary first LCD panel and an exemplary receiving container taken along line III-III′ in FIG. 6; and

FIG. 8 is a cross-sectional view illustrating a fourth exemplary embodiment of an exemplary first LCD panel and an exemplary receiving container of an LCD device according to the present invention.

### DETAILED DESCRIPTION OF THE INVENTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like reference numerals refer to similar or identical elements throughout. In the drawings, the thickness of layers, films, and regions may be exaggerated for clarity. It will be understood that when an element such as a layer, film, region or substrate is referred to as being “on” another element, it can be directly on the other element or intervening elements may also be present.

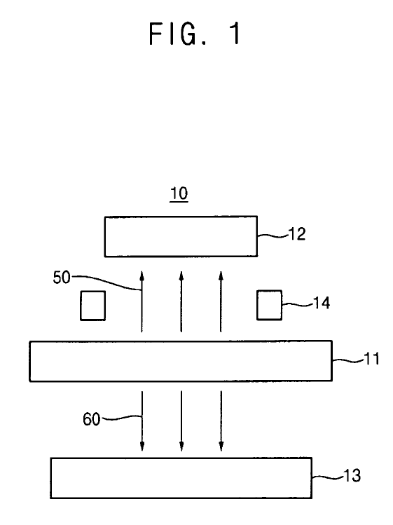

FIG. 1 is a schematic view illustrating an exemplary embodiment of a display device according to the present invention.

Referring to FIG. 1, a display device 10 includes a backlight assembly 11, a first display panel 12, a second display panel 13, and a control member 14.

The backlight assembly 11 emits a first light 50 and a second light 60. For example, the first light 50 and the second light 60 have a substantially opposite direction to each other. The backlight assembly 11 may be interposed between the first display panel 12 and the second display panel 13 such that the first light 50 and the second light 60 are emitted in substantially diametrically opposite directions.

The first and second display panels 12 and 13 receive the first and second lights 50 and 60 to display a first image and a second image, respectively. The first display panel 12 is disposed on a first side of the backlight assembly 11 to display the first image using the first light 50 emitted from the backlight assembly 11. The second display panel 13 is disposed on a second side, opposite the first side, of the backlight assembly 11 to display the second image using the second light 60 emitted from the backlight assembly 11.

The control member 14, for example, is disposed between the backlight assembly 11 and the first display panel 12 to control an interval therebetween as shown in FIG. 1. Alternatively, the control member 14 may be disposed between the backlight assembly 11 and the second display panel 13 to control an interval therebetween. While two control members 14 are illustrated, there may be as many or as few control members 14 as necessary to control the interval between the backlight assembly 11 and the associated display panel. The control member 14 is sized to prevent the blockage of the first and second lights 50, 60 to the first and second display panels 12, 13, respectively.

### Embodiment 1

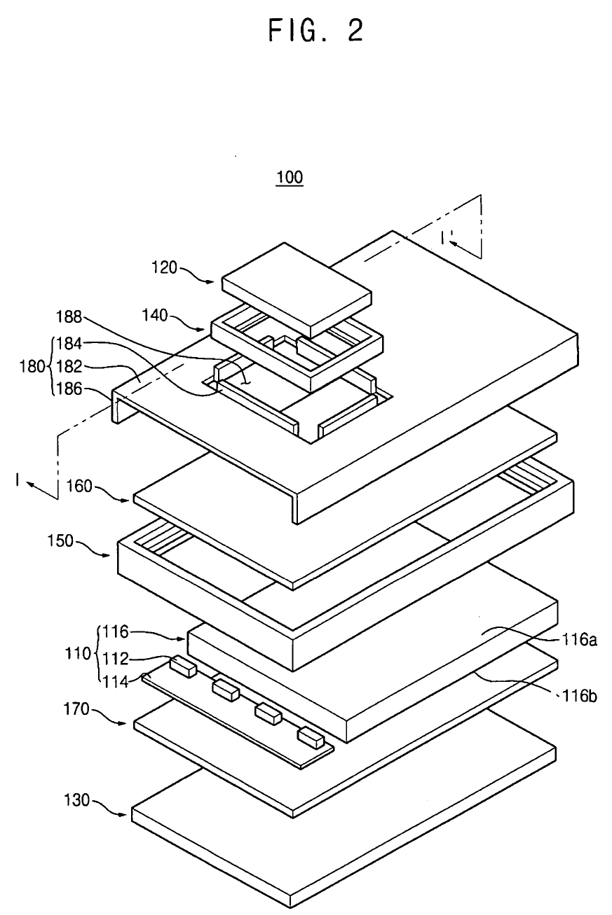

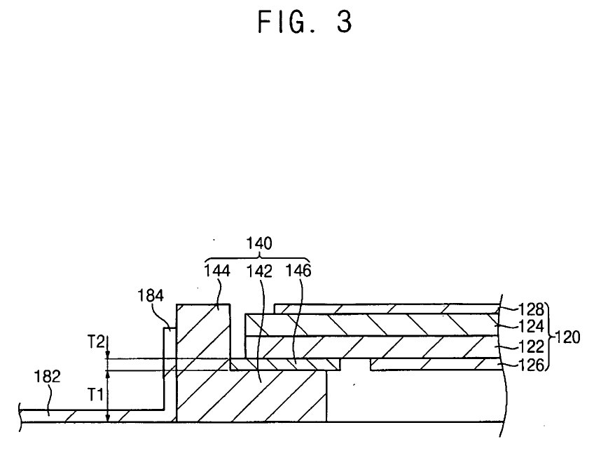

FIG. 2 is an exploded perspective view illustrating a first exemplary embodiment of an LCD device according to the present invention. FIG. 3 is a cross-sectional view of an exemplary first LCD panel and an exemplary receiving container taken along line I-I′ in FIG. 2.

Referring to FIGS. 2 and 3, an LCD device 100 includes a backlight assembly 110, a first LCD panel 120, a second LCD panel 130, a first mold frame 140, a second mold frame 150, a first optical sheet 160, a second optical sheet 170, and a receiving container 180.

The backlight assembly 110 includes a plurality of light emitting diodes (“LEDs”) 112, a printed circuit board (“PCB”) 114, and a light guiding plate 116. While LEDs are disclosed as the light source for the backlight assembly 110 of this embodiment, alternate light sources would also be within the scope of these embodiments.

The LEDs 112 generate light in response to an external power. The LEDs 112, for example, include a white LED emitting white light, although other applications of the LCD device 100 may employ varying colors of LEDs. The LEDs 112 are electrically connected to the PCB 114 to receive the external power.

The light guiding plate 116 has a substantially flat plate shape. The light guiding plate 116 has a first face 116a, serving as a first light exiting face, and a second face 116b, serving as a second light exiting face, where the second face 116b is opposite the first face 116a. Light from the LEDs 112 is incident into a light incident side of the light guiding plate 116 and the light guiding plate 116 guides the light emitted from the LEDs 112 along a substantially horizontal direction, such as generally parallel to the first and second LCD panels 120, 130, and then emits a first light through the first face 116a and a second light through the second face 116b. The first and second lights correspond to planar light and the first and second lights are emitted in a generally perpendicular direction towards the first and second LCD panels 120, 130. The light guiding plate 116, for example, has a substantially flat plate shape, so that the light guiding plate 116 has a uniform thickness from a first edge portion thereof, the light incident side, adjacent to the LEDs 112 to a second edge portion thereof opposite to the first edge portion.

Alternatively, the light guiding plate 116 may have a wedge shape. Thus, a thickness of the light guiding plate 116 may be gradually thinner from the first edge portion, the light incident side, to the second edge portion opposite the first edge portion.

The backlight assembly 110 optionally includes a transflective sheet (not shown) disposed over the first face 116a of the light guiding plate 116. The transflective sheet selectively reflects a portion of the first light and selectively transmits a portion of the first light. That is, the transflective sheet partially transmits the first light toward the first LCD panel 120, and partially reflects the first light back toward the light guiding plate 116. In the present embodiment, the first LCD panel 120 has a smaller size than the second LCD panel 130, and therefore the first LCD panel 120 may require a lesser amount of light than the second LCD panel 130. Thus, for exemplary purposes only, the transflective sheet may transmit about 30% of the first light towards the first LCD panel 120, and reflect about 70% of the first light back toward the light guiding plate 116. Of course, the first light may be alternatively divided into varying amounts as necessary, depending on the size of the first LCD panel 120 as compared to the second LCD panel 130.

In the illustrated embodiment, the backlight assembly 110 includes one light guiding plate 116. Alternatively, the light guiding plate 116 may be divided into a first light guiding plate and a second light guiding plate, where the first light guiding plate would be positioned between the second light guiding plate and the first LCD panel 120, and the second light guiding plate would be positioned between the first light guiding plate and the second LCD panel 130. The first light guiding plate may guide the light emitted from the LEDs 112 along a substantially horizontal direction, and then emit the guided light toward the first LCD panel 120. The second light guiding plate may guide the light emitted from the LEDs 112 along a substantially horizontal direction, and then emit the guided light toward the second LCD panel 130. In such an embodiment, the backlight assembly 110 may further include a light-reflecting member interposed between the first and second light guiding plates. The light-reflecting member would reflect light leaking from the first and second light guiding plates toward the first and second light guiding plates 120, 130, respectively.

The first and second LCD panels 120 and 130 display first and second images using the first and second lights, respectively. The first and second LCD panels 120 and 130 are disposed over the first and second faces 116a and 116b of the light guiding plate 116, respectively. That is, the first face 116a faces towards the first LCD panel 120, and the second face 116b faces towards the second LCD panel 130.

The first LCD panel 120 includes a thin film transistor (“TFT”) substrate 122, a color filter substrate 124, and a liquid crystal layer (not shown). The TFT substrate 122 includes pixel electrodes arranged in a matrix shape, TFTs applying a driving voltage to the pixel electrodes, gate lines, and data lines. The color filter substrate 124 includes color filters facing the pixel electrodes of the TFT substrate 122 and a common electrode formed on the color filters. The liquid crystal layer is interposed between the TFT substrate 122 and the color filter substrate 124. In an alternative embodiment, the color filters may be formed on the TFT substrate 122.

A first polarized film 126 and a second polarized film 128 are disposed on the TFT substrate 122 and the color filter substrate 124, respectively. The first and second polarized films 126 and 128 adjust a transmission direction of light externally provided into the TFT substrate 122 and the color filter substrate 124, respectively, in accordance with an aligned direction of the liquid crystal layer disposed therebetween. The first and second polarized films 126 and 128 have first and second polarized axes thereof substantially perpendicular to each other, respectively.

The second LCD panel 130 may have a structure and a function substantially identical to the first LCD panel 120. However, in the present embodiment, the first LCD panel 120 has a size smaller than the second LCD panel 130. In other words, the first image has a size smaller than the second image. In an alternative embodiment, the second LCD panel 130 may be smaller in size than the first LCD panel 120.

The first and second mold frames 140 and 150 each have a frame structure for receiving and supporting the first and second LCD panels 120 and 130, respectively. In the present embodiment, since the first LCD panel 120 has a smaller size than the second LCD panel 130, the first mold frame 140 has an accordingly smaller size than the second mold frame 150.

The first mold frame 140 includes a support 142 supporting the first LCD panel 120 and a sidewall 144 protruded from the support 142 toward the first LCD panel 120. The support 142 may be a substantially rectangularly shaped flat frame having an inner periphery defining an opening for allowing the passage of light therethrough. The sidewall 144 may extend substantially perpendicularly from an outer periphery of the support 142 to surround an outermost periphery of the first LCD panel 120. The first mold frame 140 further includes a tape panel 146 between the support 142 and the first LCD panel 120 to combine the first LCD panel 120 and the first mold frame 140 with each other such as by adhering the first LCD panel 120 to the first mold frame 140 and preventing relative movement. In the illustrated embodiment, the tape panel 146 is adhered to a surface of the TFT substrate 122 rather than the first polarized film 126. Alternate embodiments may extend the first polarized film 126 such that the first polarized film 126 is interposed between the tape panel 146 and the TFT substrate 122, with the tape panel 146 interposed between the first polarized film 126 and the support 142. In any case, the tape panel 146 adheres a surface of the first LCD panel 120 to the support 142. The tape panel 146 may include a strip of double sided adhesive tape, a strip of adhesive, etc.

The second mold frame 150 receives and supports, in part, the first and second optical sheets 160 and 170.

The first and second optical sheets 160 and 170 are disposed over the first face 116a and under the second face 116b of the light guiding plate 116, respectively. Thus, the first optical sheet 160 is positioned between the light guiding plate 116 and the first LCD panel 120 and the second optical sheet 170 is positioned between the light guiding plate 116 and the second LCD panel 130. The first and second optical sheets 160 and 170 include, for example, a light-diffusing sheet, a prism sheet, a dual brightness enhancement film (“DBEF”), etc. The light-diffusing sheet enhances luminance uniformity of the light emitted from the light guiding plate 116. The prism sheet improves a viewing angle of a displayed image. The DBEF increases luminance and enlarges a viewing angle of the displayed image. In some embodiments, not all of the above-described sheets need be included, or other additional sheets may be included. The first optical sheet 160 may include the same set or a different set of sheets from the second optical sheet 170, depending on optical requirements for the first and second LCD panels 120, 130. In yet other alternative embodiments, one or both of the first and second optical sheets 160, 170 may be eliminated from the LCD device 100 if unnecessary.

The receiving container 180 includes a bottom plate 182, a plurality of guides 184 and a plurality of sidewalls 186. The bottom plate 182 may be substantially planar and generally parallel with the first LCD panel 120. A central portion of the bottom plate 182 of the receiving container 180 is removed to form an opening 188. The opening 188 may be formed at any location within the boundaries of the bottom plate 182, and may have any size complimentary to a size of the first LCD panel 120. The guides 184 are protruded from a portion of the bottom plate 182 adjacent to the opening 188 to define a first receiving space. In the illustrated embodiment, the guides 184 protrude in a direction away from the backlight assembly 110. While one guide 184 is illustrated as positioned on each side of the opening 188, a plurality of smaller guides 184 may be positioned on one or more opposing sides of the opening 188, or only one pair of guides 184 may be employed. The first LCD panel 120 and the first mold frame 140 receiving the first LCD panel 120 are placed in the first receiving space. The first mold frame 140 and the guides 184 are combined with each other through a combining member. For example, a hook (not shown) may be formed on an outer surface of the sidewall 144 of the first mold frame 140, and a throughhole corresponding to the hook may be formed on the guides 184 of the receiving container 180, so that the first mold frame 140 and the receiving container 180 may be combined with each other therethrough.

The sidewalls 186 are integrally formed with the bottom plate 182, and extended in a generally perpendicular direction from the bottom plate 182 toward the second mold frame 150 to define a second receiving space. The first optical sheet 160, the second mold frame 150, the backlight assembly 110, the second optical sheet 170, and the second LCD panel 130 are successively placed in the second receiving space.

In the present embodiment, the support 142 of the first mold frame 140 is employed as a control member that controls an interval between the first LCD panel 120 and the receiving container 180, thereby defining a spacing between a surface of the first LCD panel 120 and a surface of the receiving container 180.

Referring again to FIG. 3, the support 142 and the tape panel 146 of the first mold frame 140 have a first thickness T1 and a second thickness T2, respectively. An interval between a surface of the bottom plate 182 of the receiving container 180 and a surface of the first LCD panel 120 is varied by controlling the size of the first and second thicknesses T1 and T2. Since the second thickness T2 of the tape panel 146 is relatively thin, the interval may be more easily or readily varied by controlling the size of the first thickness T1 of the support 142.

Thus, according to the present embodiment, the control member is placed between a backlight assembly and an LCD panel, so that an interval therebetween may be controlled. Particularly, the first LCD panel having a size smaller than the second LCD panel is spaced apart from the receiving container 180 by a desired distance, thereby emphasizing the first LCD panel and diversifying a design of the LCD device.

### Embodiment 2

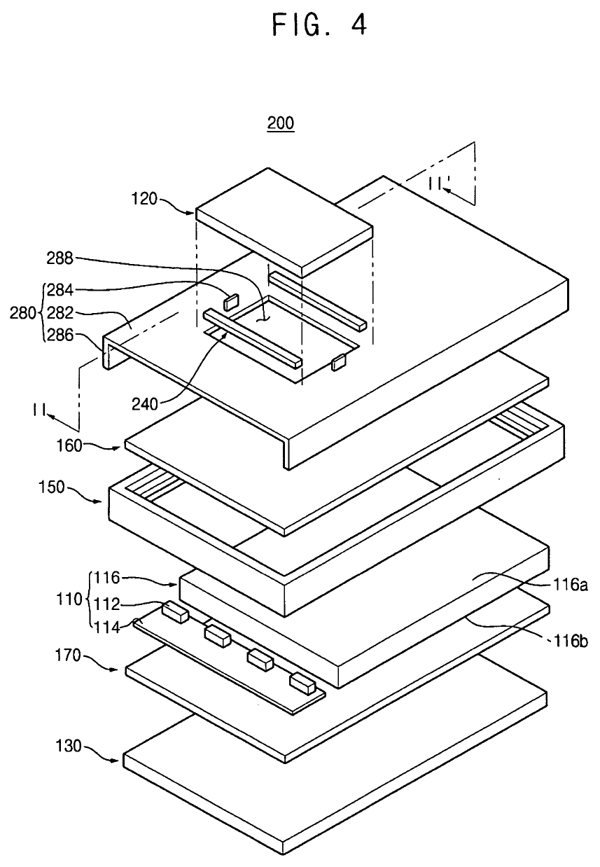

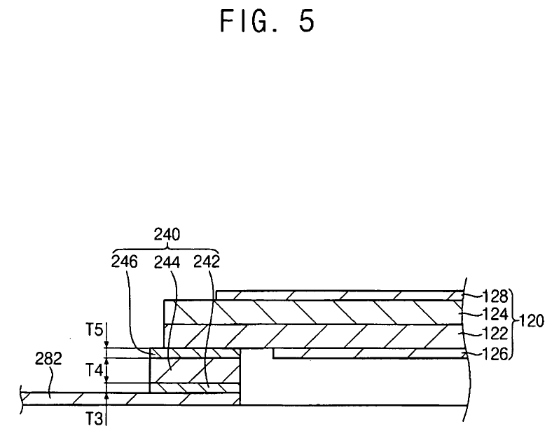

FIG. 4 is an exploded perspective view illustrating a second exemplary embodiment of an LCD device according to the present invention. FIG. 5 is a cross-sectional view of an exemplary first LCD panel and an exemplary receiving container taken along line II-II′ in FIG. 4. The LCD device of the present embodiment is substantially identical to the LCD device of Embodiment 1 except for a receiving container and a first mold frame. Thus, any further description for the substantially same elements will be omitted.

Referring to FIGS. 4 and 5, the LCD device 200 includes a backlight assembly 110, a first LCD panel 120, a second LCD panel 130, a tape panel 240, a second mold frame 150, a first optical sheet 160, a second optical sheet 170, and a receiving container 280.

The receiving container 280 includes a substantially planar bottom plate 282, a plurality of guides 284, and a plurality of sidewalls 286. A central portion of the bottom plate 282 of the receiving container 280 is removed to form an opening 288. The opening 288 may be located at any location within the outer boundaries of the bottom plate 282 and may be sized to allow sufficient light to pass from the light guiding plate 116 to the first LCD panel 120.

The guides 284 are protruded from a portion of the bottom plate 282 adjacent to the opening 288 to define a first receiving space. The guides 284 may extend in a direction facing away from the light guiding plate 116. The guides 284 may be integrally or separately formed with the bottom plate 282. While one pair of guides 284 having a smaller size than a side of the opening 288 is illustrated, the guides 284 may be varyingly sized and positioned. The first LCD panel 120 is placed in the first receiving space formed by the guides 284.

The sidewalls 286 are integrally formed with the bottom plate 282, and extend perpendicularly from the bottom plate 282 toward the second mold frame 150 to define the second receiving space. The backlight assembly 110, the second LCD panel 130, the second mold frame 150, the first optical sheet 160, and the second optical sheet 170 are successively placed in the second receiving space.

In the present embodiment, the tape panel 240 is employed as a control member that controls an interval between the first LCD panel 120 and the receiving container 280. That is, a spacing between a surface, such as a planar surface of the bottom plate 282, of the receiving container 280 and a surface, such as a planar surface, of the first LCD panel 120 is altered by altering a size of the tape panel 240.

The tape panel 240 is disposed on the bottom plate 282 adjacent to the opening 288 of the receiving container 280 to combine the first LCD panel 120 and the receiving container 280 with each other. As illustrated, the tape panel 240 is positioned on opposing pair of sides of the opening 288, and extends approximately the same length as the side of the opening 288. In alternative embodiments, the tape panel 240 may be positioned in an alternate number of locations and may be alternatively sized. The tape panel 240 includes, for example, a first sub tape panel 242, a thickness controlling layer 244 layered on the first sub tape panel 242, and a second sub tape panel 246 layered on the thickness controlling layer 244. Each of the first sub tape panel 242 and the second sub tape panel 246 may include an adhering surface on both sides of the panels. The first sub tape panel 242 has a third thickness T3, and combines the thickness controlling layer 244 and the bottom plate 282. The second sub tape panel 246 has a fifth thickness T5, and combines the thickness controlling layer 244 and the first LCD panel 120. The thickness controlling layer 244 has a fourth thickness T4, and is interposed between the first and second sub tape panels 242 and 246 to support the first LCD panel 120. The thickness controlling layer 244 may include a material capable of supporting the first LCD panel 120 such as, for example, polyethylene terephthalate (“PET”).

The interval between a surface of the bottom plate 282 of the receiving container 280 and a surface of the first LCD panel 120 may be varied by controlling the third, fourth, and fifth thicknesses T3, T4, and T5. The third thickness T3 of the first sub tape panel 242 and the fifth thickness T5 of the second sub tape panel 246 are relatively thin, so therefore the interval may be more easily or readily varied by controlling the fourth thickness T4 of the thickness controlling layer 244. That is, a spacing between a surface, such as a planar surface of the bottom plate 282, of the receiving container 280 and a surface, such as a planar surface, of the first LCD panel 120 may be altered by altering a size of the fourth thickness T4 of the thickness controlling layer 244.

In the present embodiment, the tape panel 240 includes the first sub tape panel 242, one thickness controlling layer 244, and the second sub tape panel 246. Alternatively, the tape panel 240 may include one or more additional layers to control the interval between the bottom plate 282 of the receiving container 280 and the first LCD panel 120. For example, when a plurality of standardized layers each having a relatively thin thickness is employed as the thickness controlling layer 244, the interval may be controlled more effectively. That is, a manufacturer may easily determine an interval between a surface of the first LCD panel 120 and a surface of the bottom plate 282 by a number of layers used in the thickness controlling layer 244.

Thus, according to the present embodiment, the control member is placed between a backlight assembly and an LCD panel, so that an interval therebetween may be controlled. Particularly, when an LCD device does not include a mold frame receiving the LCD panel, the LCD panel may be spaced apart from the receiving container by a desired distance.

### Embodiment 3

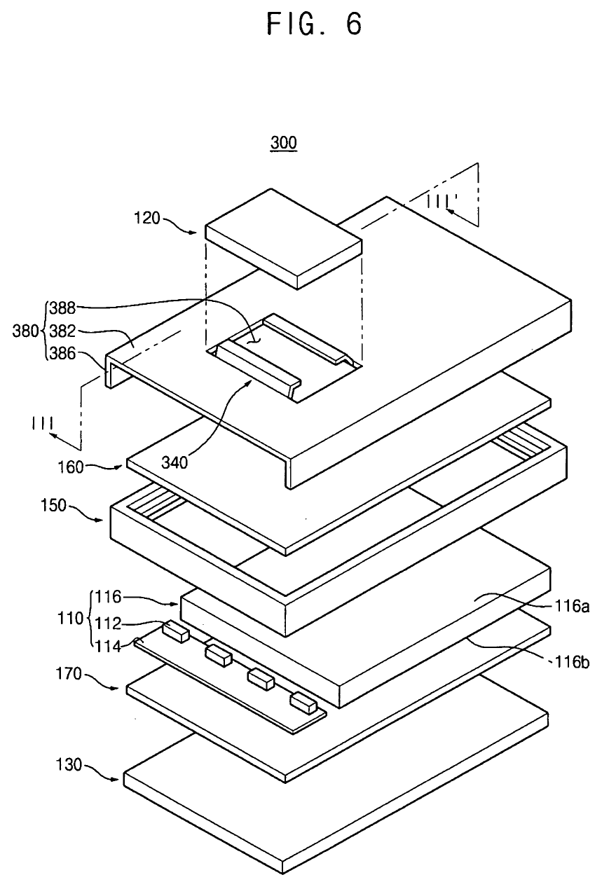

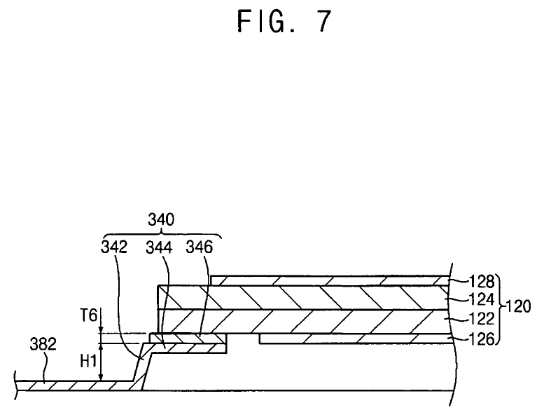

FIG. 6 is an exploded perspective view illustrating a third exemplary embodiment of an LCD device according to the present invention. FIG. 7 is a cross-sectional view of an exemplary first LCD panel and an exemplary receiving container taken along line III-III′ in FIG. 6. The LCD device of the present embodiment is substantially identical to the LCD device of Embodiment 2 except for a receiving container. Thus, any further description for the substantially same elements will be omitted.

Referring to FIGS. 6 and 7, an LCD device 300 includes a backlight assembly 110, a first LCD panel 120, a second LCD panel 130, a protruded portion 340, a second mold frame 150, a first optical sheet 160, a second optical sheet 170, and a receiving container 380.

The receiving container 380 includes a bottom plate 382 and a plurality of sidewalls 386. The bottom plate 382 may be substantially planar and generally parallel to the first LCD panel 120. A central portion of the bottom plate 382 of the receiving container 380 is removed to form an opening 388. The opening 388 may be sized and positioned within the bottom plate 382 as necessary to allow for a sufficient amount of light from the backlight assembly 110 to pass through the opening 388 to the first LCD panel 120.

In the present embodiment, a plurality of protruded portions 340 is employed as a control member that controls an interval between the first LCD panel 120 and the receiving container 380. In other words, the protruded portions 340 determine a spacing between a surface of the first LCD panel 120 and a surface of the bottom plate 382.

At least a portion of the protruded portions 340 may be integrally formed with the bottom plate 382 of the receiving container 380. A first side of each of the protruded portions 340 is attached to the bottom plate 382, and a second side of each of the protruded portions 340 is distanced from the bottom plate 382. Particularly, the protruded portions 340 are protruded from a portion of the bottom plate 382 adjacent to the opening 388. While the illustrated embodiment shows two protruded portions 340, one on each side of a pair of opposing sides of the opening 388, more protruded portions 340 employed on two or more sides of the opening 388 would also be within the scope of these embodiments. Each of the protruded portions 340 includes an extension portion 342 extended from the bottom plate 382 of the receiving container 380 toward the first LCD panel 120 by a first height H1. A first end of the extension portion 342 may be integrally formed with the bottom plate 382. Each of the protruded portions 340 further includes a support portion 344 extended from a second end of the extension portion 342 along a direction substantially parallel with the first LCD panel 120 to support the first LCD panel 120. The first LCD panel 120 is placed on the support portion 344, and a tape panel 346 having a sixth thickness T6 is interposed between the support portion 344 and the first LCD panel 120 to combine the first LCD panel 120 and the protruded portion 340 with each other and prevent relative movement therebetween.

An interval between a surface of the bottom plate 382 of the receiving container 380 and a surface of the first LCD panel 120 may be varied by controlling the first height H1 and the sixth thickness T6. Particularly, since the sixth thickness T6 of the tape panel 346 is relatively thin, the interval may be easily varied by controlling the first height H1 of the protruded portion 340.

The receiving container 380 optionally includes guides (not shown) protruded from the bottom plate 382 neighboring the protruded portions 340. The guides are extended from a portion of the bottom plate 382 adjacent to the opening 388 to define a first receiving space. By example only, the guides may be positioned such as similar to guides 284 shown in FIG. 4, and may extend further than the first height H1. The first LCD panel 120 is received in the first receiving space.

Each of the sidewalls 386 of the receiving container 380 is integrally formed with the bottom plate 382, and is protruded substantially perpendicularly from the bottom plate 382 to define a second receiving space. The backlight assembly 110, the second LCD panel 130, the second mold frame 150, the first optical sheet 160, and the second optical sheet 170 are received in the second receiving space.

In the present embodiment, the receiving container 380 includes one pair of protruded portions 340 corresponding to each other. Alternatively, the receiving container 380 may further include an additional pair of protruded portions 340 protruded from the bottom plate 382 neighboring the illustrated protruded portions 340.

Thus, according to the present embodiment, the control member is placed between a backlight assembly and an LCD panel, so that an interval therebetween may be controlled. Particularly, when an LCD device does not include a mold frame receiving the LCD panel, the LCD panel may be spaced apart from the receiving container by a desired distance. In addition, the control member is integrally formed with the receiving container, so that a manufacturing process thereof may be simplified.

### Embodiment 4

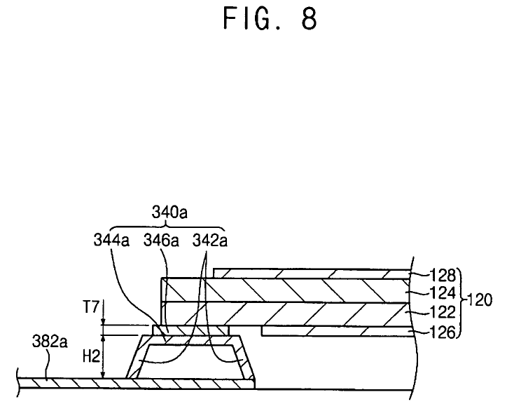

FIG. 8 is a cross-sectional view illustrating an exemplary first LCD panel and an exemplary receiving container of a fourth exemplary embodiment of an LCD device according to the present invention. The LCD device of the present embodiment is substantially identical to the LCD device of Embodiment 3 except for a bottom plate and a protruded portion of a receiving container. Thus, any further description for the substantially same elements will be omitted.

In the present embodiment, a plurality of protruded portions 340a is employed as a control member that controls an interval between a first LCD panel 120 and a receiving container.

At least a portion of the protruded portions 340a may be integrally formed with the receiving container. A pair of sides of each of the protruded portions 340a is attached to the bottom plate 382a. Particularly, the protruded portions 340a are protruded from a first portion of the bottom plate 382a adjacent to the opening 388 and protruded from a second portion of the bottom plate 382a spaced apart from the opening 388 by a predetermined distance. Each of the protruded portions 340a includes extension portions 342a extended from the bottom pate 382a toward the first LCD panel 120 by a second height H2. A first end of a first extension portion 342a may extend from the first portion of the bottom plate 382a and a first end of a second extension portion 342a may extend from the second portion of the bottom plate 382a. The first end of the first extension portion 342a and the first end of the second extension portion 342a may be integrally formed with the bottom plate 382a. A support portion 344a connects a second end of the first extension portion 342a to a second end of the second extension portion 342a along a direction substantially parallel with the first LCD panel 120 to support the first LCD panel 120. The support portion 344a may be integrally formed with the extension portions 342a. The first LCD panel 120 is placed on the support portion 344a, and a tape panel 346a having a seventh thickness T7 is interposed therebetween to combine the first LCD panel 120 and the protruded portion 340a with each other.

An interval between a surface of the bottom plate 382a and a surface of the first LCD panel 120 may be varied by controlling the second height H2 and the seventh thickness T7. Particularly, since the seventh thickness T7 of the tape panel 346a is relatively thin, the interval may be more easily varied by controlling the second height H2 of the protruded portion 340a.

Similar to the receiving container of Embodiment 3, the receiving container of the present embodiment may include a pair of protruded portions 340a corresponding to opposite sides of an opening on the bottom plate 382a. Alternatively, the receiving container may additionally include an extra pair of protruded portions 340a corresponding to each other and neighboring the other pair of protruded portions 340a. The protruded portion 340a may be formed on the support of the first mold frame of Embodiment 1.

According to the present embodiment, the control member is placed between a backlight assembly and an LCD panel, so that an interval therebetween may be controlled. Particularly, when an LCD device does not include a mold frame receiving the LCD panel, the LCD panel may be spaced apart from the receiving container by a desired distance. In addition, the control member is integrally formed with the receiving container, so that a manufacturing process thereof may be simplified.

A method of positioning a first display panel in a display device according to the above described embodiments thus may include determining a first spacing between the backlight assembly and the first display panel desired for emphasizing the first display panel, determining a second spacing between the bottom plate and the first display panel for acquiring the first spacing, and providing a control member between the bottom plate and the first display panel to achieve the second spacing. The method further includes placing the control member adjacent at least one side of the opening in the bottom plate of the receiving container. The method may include selecting a mold frame as the control member, providing the mold frame with a support supporting the first display panel, and selecting a thickness of the support required for forming at least part of the second spacing. The method may alternatively include selecting a tape panel as the control member, providing the tape panel with a thickness controlling layer, selecting a thickness of the thickness controlling layer required for forming at least part of the second spacing, and adhering the thickness controlling layer between the bottom plate and the first display panel, wherein selecting a thickness of the thickness controlling layer includes selecting layers from a set of layers, layering the selected layers, and forming the thickness controlling layer from the selected layers. The method may alternatively include selecting a protruding member as the control member, selecting a height of the protruding member required for forming at least part of the second spacing, and integrally forming the protruding member with the bottom plate.

According to the above-described embodiments of the present invention, the control member is placed between a backlight assembly and a display panel unit, so that an interval therebetween may be controlled. Particularly, a first display panel having a size smaller than a second display panel is spaced apart from a receiving container by a desired distance, thereby emphasizing the first display panel and diversifying a design of the display device. By spacing the first display panel from the receiving container, the first display panel becomes further spaced from the backlight assembly. Thus, the first display panel is emphasized without increasing the thickness of the first display panel.

In addition, when a display device does not include a mold frame receiving the display panel, the display panel may be spaced apart from the receiving container by a desired distance.

Moreover, in some embodiments, the control member may be integrally formed with the receiving container, so that a manufacturing process thereof may be simplified.

Furthermore, the above-described structure may be employed in an LCD device, thereby emphasizing an LCD panel of the LCD device and diversifying a design of the LCD device.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed. Moreover, the use of the terms first, second, etc. do not denote any order or importance, but rather the terms first second, etc. are used to distinguish one element from another. Furthermore, the use of the terms a, an, etc. do not denote a limitation of quantity, but rather denote the presence of at least one of the referenced item.

What is claimed is:

1. A display device comprising:
a backlight assembly emitting a first light and a second light;
a display panel unit receiving the first light and the second light and displaying a first image and a second image, respectively; and
a control member controlling a first interval between the backlight assembly and the display panel unit.

2. The display device of claim 1, wherein the display panel unit comprises:
a first display panel disposed on a first side of the backlight assembly displaying the first image using the first light emitted from the backlight assembly; and
a second display panel disposed on a second side of the backlight assembly displaying the second image using the second light emitted from the backlight assembly.

3. The display device of claim 2, wherein the first display panel is smaller than the second display panel, and the control member controls the first interval between the backlight assembly and the first display panel.

4. The display device of claim 2, further comprising a receiving container receiving the first and second display panels and having a bottom plate.

5. The display device of claim 4, wherein the bottom plate includes an opening, the opening passing the first light from the backlight assembly to the first display panel.

6. The display device of claim 4, wherein the control member controls the first interval by controlling a second interval between the bottom plate of the receiving container and the first display panel.

7. The display device of claim 4, wherein the receiving container provides a first receiving space where the first display panel is disposed and a second receiving space where the second display panel is disposed.

8. The display device of claim 7, wherein the first receiving space is positioned on one side of a planar surface of the bottom plate, and the second receiving space is positioned on an opposite side of the planar surface of the bottom plate.

9. The display device of claim 7, wherein the control member comprises a mold frame disposed in the first receiving space, the mold frame supporting the first display panel.

10. The display device of claim 9, wherein the mold frame comprises:
a support having a first thickness, the support supporting the first display panel; and
a sidewall protruded from the support, the sidewall defining the first receiving space.

11. The display device of claim 10, wherein the first interval is varied by controlling the first thickness.

12. The display device of claim 10, wherein the mold frame further comprises a tape panel disposed between the support and the first display panel, the tape panel having a second thickness.

13. The display device of claim 12, wherein the first interval is varied by controlling the first thickness and the second thickness.

14. The display device of claim 4, wherein the control member comprises a tape panel disposed between the receiving container and the first display panel.

15. The display device of claim 14, wherein the tape panel is positioned adjacent at least one side of an opening provided in the bottom plate of the receiving container, the opening passing the first light from the backlight assembly to the first display panel.

16. The display device of claim 14, wherein the tape panel comprises:
a first sub tape panel having a first thickness;
a thickness controlling layer layered on the first sub tape panel and having a second thickness; and
a second sub tape panel layered on the thickness controlling layer and having a third thickness.

17. The display device of claim 16, wherein the first interval is varied by controlling at least one of the first thickness, the second thickness, and the third thickness.

18. The display device of claim 16, wherein the thickness controlling layer includes polyethylene terephthalate.

19. The display device of claim 16, wherein the thickness controlling layer comprises a plurality of layers of a material layered together to form the thickness controlling layer.

20. The display device of claim 4, wherein the control member comprises a protruded portion formed on the bottom plate of the receiving container, the protruded portion supporting the first display panel.

21. The display device of claim 20, wherein the protruded portion is integrally formed with the bottom plate.

22. The display device of claim 20, wherein a first side of the protruded portion is attached to the bottom plate, and a second side of the protruded portion is distanced from the bottom plate.

23. The display device of claim 20, wherein the first interval is varied by controlling a height of the protruded portion.

24. The display device of claim 20, wherein the first display panel and the protruded portion are combined with each other by a tape panel therebetween having a thickness.

25. The display device of claim 24, wherein the first interval is varied by controlling a height of the protruded portion and the thickness of the tape panel.

26. The display device of claim 2, wherein each of the first and second display panels comprises:
a thin film transistor substrate including pixel electrodes arranged in a matrix shape and thin film transistors providing the pixel electrodes with driving voltages;
a color filter substrate including color filters corresponding to the pixel electrodes and a common electrode formed on the color filters; and
a liquid crystal layer interposed between the thin film transistor substrate and the color filter substrate.

27. The display device of claim 1, wherein the backlight assembly comprises:
a light emitting diode emitting light; and
a light guiding plate guiding the light emitted from the light emitting diode and emitting the first and second lights.

28. The display device of claim 27, wherein the backlight assembly further comprises a transflective sheet disposed at a side of the light guiding plate through which the first light exits the light guiding plate, the transreflective sheet transmitting a first portion of the first light to the display panel unit and reflecting a second portion of the first light back toward the light guiding plate.

29. The display device of claim 28, wherein the transflective sheet transmits less than about fifty percent of the first light.

30. The display device of claim 27, wherein the light guiding plate comprises:
a first light guiding plate emitting the first light; and
a second light guiding plate emitting the second light.

31. The display device of claim 30, wherein the backlight assembly further comprises a light-reflecting plate between the first and second light guiding plates.

32. A liquid crystal display device comprising:
a backlight assembly emitting a first light and a second light;
a first liquid crystal display panel disposed on a first side of the backlight assembly, the first liquid crystal display displaying a first image using the first light emitted from the backlight assembly;
a second liquid crystal display panel disposed on a second side of the backlight assembly, the second liquid crystal display displaying a second image using the second light emitted from the backlight assembly;
a receiving container receiving the first and second liquid crystal display panels and having a bottom plate; and
a mold frame disposed on a side of the receiving container, the mold frame supporting the first display panel, the mold frame controlling an interval between the backlight assembly and the first liquid crystal display panel.

33. The liquid crystal display device of claim 32, wherein the mold frame comprises:
a support having a first thickness, the support supporting the first liquid crystal display panel; and
a sidewall protruded from the support, the sidewall defining a receiving space where the first liquid crystal display panel is disposed; and
a tape panel disposed between the support and the first liquid crystal display panel, the tape panel having a second thickness.

34. The liquid crystal display device of claim 33, wherein the interval is varied by controlling at least one of the first thickness and the second thickness.

35. A liquid crystal display device comprising:
a backlight assembly emitting a first light and a second light;
a first liquid crystal display panel disposed on a first side of the backlight assembly, the first liquid crystal display displaying a first image using the first light emitted from the backlight assembly;
a second liquid crystal display panel disposed on a second side of the backlight assembly, the second liquid crystal display displaying a second image using the second light emitted from the backlight assembly; and
a receiving container receiving the first and second liquid crystal display panels and having a bottom plate, the receiving container controlling an interval between the backlight assembly and the first liquid crystal display panel.

36. The liquid crystal display device of claim 35, wherein the receiving container comprises a tape panel disposed between the receiving container and the first liquid crystal display panel.

37. The liquid crystal display device of claim 36, wherein the tape panel comprises:
a first sub tape panel having a first thickness;
a thickness controlling layer layered on the first sub tape panel and having a second thickness; and
a second sub tape panel layered on the thickness controlling layer and having a third thickness.

38. The liquid crystal display device of claim 37, wherein the interval between the backlight assembly and the first liquid crystal display panel is varied by controlling at least one of the first thickness, the second thickness, and the third thickness.

39. The liquid crystal display device of claim 35, wherein the receiving container comprises a protruded portion formed on the bottom plate of the receiving container, the protruded portion supporting the first liquid crystal display panel.

40. The liquid crystal display device of claim 39, wherein the interval between the backlight assembly and the first liquid crystal display panel is varied by controlling a height of the protruded portion.

41. The liquid crystal display device of claim 39, wherein the first liquid crystal display panel and the protruded portion are combined with each other by a tape panel therebetween having a thickness.

42. The liquid crystal display device of claim 41, wherein the interval between the backlight assembly and the first liquid crystal display panel is varied by controlling at least one of a height of the protruded portion and the thickness of the tape panel.

43. A liquid crystal display device comprising:
a backlight assembly having a light source that emits a first light and a second light;
a first liquid crystal display panel disposed on a first side of the backlight assembly, the first liquid crystal display displaying a first image using the first light emitted from the backlight assembly;
a second liquid crystal display panel disposed on a second side of the backlight assembly, the second liquid crystal display displaying a second image using the second light emitted from the backlight assembly; and
a receiving container receiving the first and second liquid crystal display panels and including a bottom plate and a guide that is extended from the bottom plate, the guide defining a receiving space where the first liquid crystal display panel is disposed.

44. The liquid crystal display device of claim 43, further comprising a mold frame disposed on a first side of the receiving container, the mold frame supporting the first liquid crystal display panel, the mold frame being combined with the guide using a hook.

45. The liquid crystal display device of claim 43, wherein the guide supports the first liquid crystal display panel, and the receiving container further includes a combination member combining the first liquid crystal display panel and the receiving container with each other.

46. The liquid crystal display device of claim 43, wherein the light source includes a light emitting diode, and the backlight assembly comprises a light guiding plate guiding light emitted from the light emitting diode to emit the first and second lights.

47. The liquid crystal display device of claim 46, wherein the backlight assembly further comprises a transflective sheet disposed at a side of the light guiding plate through which the first light exits the light guiding plate, the transreflective sheet transmitting a first portion of the first light to the first LCD panel and reflecting a second portion of the first light back toward the light guiding plate.

48. The liquid crystal display device of claim 46, wherein the light guiding plate comprises:
a first light guiding plate emitting the first light; and
a second light guiding plate emitting the second light.

49. A method of positioning a first display panel in a display device, the display device including a receiving container having a bottom plate, the receiving container receiving the first display panel on a first side of the bottom plate and a second display panel of a second side of the bottom plate, opposite the first side, the display device further including a backlight assembly positioned between the bottom plate and the second display panel, the backlight assembly emitting a first light to the first display panel and a second light to the second display panel, the method comprising:
determining a first spacing between the backlight assembly and the first display panel for emphasizing the first display panel;
determining a second spacing between the bottom plate and the first display panel for acquiring the first spacing;
providing a control member between the bottom plate and the first display panel to achieve the second spacing.

50. The method of claim 49, wherein the first display panel is smaller than the second display panel, the bottom plate includes an opening, and the first light passes through the opening to the first display panel, the method further comprising placing the control member adjacent at least one side of the opening.

51. The method of claim 50, further comprising selecting a mold frame as the control member, providing the mold frame with a support supporting the first display panel, and selecting a thickness of the support required for forming at least part of the second spacing.

52. The method of claim 50, further comprising selecting a tape panel as the control member, providing the tape panel with a thickness controlling layer, selecting a thickness of the thickness controlling layer required for forming at least part of the second spacing, and adhering the thickness controlling layer between the bottom plate and the first display panel,

53. The method of claim 52, wherein selecting a thickness of the thickness controlling layer comprises selecting layers from a set of layers, layering the selected layers, and forming the thickness controlling layer from the selected layers.

54. The method of claim 50, further comprising selecting a protruding member as the control member, selecting a height of the protruding member required for forming at least part of the second spacing, and integrally forming the protruding member with the bottom plate.
